(19) United States
(12) Patent Application Publication
(10) Pub. No.: US 2026/0094497 A1
(43) Pub. Date: Apr. 2, 2026

(54) GAMING MACHINE AND SYSTEM WITH INTEGRATED PUBLIC ADDRESS

(71) Applicant: Everi Games Inc., Austin, TX (US)

(72) Inventors: Lawrence J. Knipp, Austin, TX (US); Carolyn Jean Fazio, Lakeway, TX (US); Mark Douglas MacDonald, Lago Vista, TX (US); William Gregory Turner, Reno, NV (US)

(73) Assignee: Everi Games Inc., Austin, TX (US)

(21) Appl. No.: 18/900,815

(22) Filed: Sep. 29, 2024

(51) Int. Cl. G07F 17/32; G06F 3/16

(52) U.S. Cl. CPC G07F 17/323; G06F 3/165; G07F 17/3276

(57) ABSTRACT

A gaming machine, public address system, and gaming system are provided with a public address system integrated into the gaming machines to use the gaming machine speakers for public address audio. The public address system includes a microphone amplifier adapted for coupling to a microphone and producing a first audio signal. An audio signal distribution module receives the first audio signal and transmits a version of the audio signal to a plurality of gaming machine audio systems. In each gaming machine audio system, a mixer operable to receive the version of the first audio signal and mix it with a second audio signal produced in the gaming machine and feed a mixed signal to an audio power amplifier circuit driving the gaming machine speakers.

### TECHNICAL FIELD OF THE INVENTION

This invention relates to gaming machines, gaming systems, and associated methods. More particularly, the invention relates to gaming machines, systems, and related methods with public address audio functionality.

### BACKGROUND OF THE INVENTION

Many different types of gaming machines have been developed to provide various formats and graphic presentations for conducting games and presenting game results. For example, numerous mechanical and video reel gaming machines, also known as slot machines, have been developed with different reel configurations, reel symbols, and paylines.

Group games are used with slot machines to improve the variety of prizes and game playing experiences available. For example, some games provide that a bank of gaming machines enter a group bonus mode in which higher value prizes are awarded. Other games provide a group event such as a tournament, in which high value prizes are awarded to certain individual gaming machines that obtain better results while wagering in the tournament.

Such slot machine tournaments may be out-of-revenue tournaments, in which player credits are not directly wagered, or in-revenue tournaments, in which players wager their credits. A casino or gaming site hosting a slot machine tournament may use a public address (PA) system, in which an announcer provides updates, commentary, and entertainment during the tournament. An example tournament PA system according to the prior art is depicted in FIG. 1, which shows a perspective representation of a bank of gaming machines 100 at which players are sitting and participating in a tournament. An announcer is shown using a PA system, which is external to the bank of gaming machines 100 and not integrated with the gaming network connected to the gaming machines, or connected to the gaming machines. The announcer holds a microphone 12, which may be wired or wireless. Microphone 12 sends an audio signal to a receiver 14, which feeds one or more power amplifiers for a pair of speakers 16. As labelled on the drawing, the speakers produce the public address “PA” audio, while the gaming machines produce their own audio from speakers along their front side, labelled “GAMING/TOURNAMEN”. Such external PA systems have numerous setbacks. They often include several power cables and signal cables, which require staff effort to set up and safely route along the casino floor or other path. External PA systems also “compete” with the audio from the gaming machine for player attention, and may be distracting to players.

### SUMMARY OF THE INVENTION

A gaming machine, public address system, and gaming system are provided with the public address system integrated into the gaming machines to use the gaming machine speakers for public address audio. The public address system includes a microphone amplifier adapted for coupling to a microphone and producing a first audio signal. An audio signal distribution module receives the first audio signal and transmits a version of the audio signal to a plurality of gaming machine audio systems. In each gaming machine audio system, a mixer operable to receive the version of the first audio signal and mix it with a second audio signal produced in the gaming machine and feed a mixed signal to an audio power amplifier circuit driving the gaming machine speakers.

An object of the present invention is to provide an improved public address system for use with casino gaming machines that provides easily discernable public address audio together with gaming machine audio. Another object of the invention is to provide a way for a group of machines receive and play public address audio while other machines which may be nearby do not. Yet another object is to reduce the amount of equipment required to perform this function, including reducing the duplication of speakers, amplifiers and wiring while increasing utilization of existing equipment. Another object of the invention is to provide a PA system that less cumbersome and consumes less space than existing PA systems. Yet another object is to provide a PA system for groups of gaming machines for which the groups are configurable.

According to a first aspect of the invention, a public address system for a group of gaming machines includes a microphone amplifier adapted for coupling to a microphone and producing a first audio signal. An audio signal distribution module is operable to receive the first audio signal and transmit a version of the audio signal to a plurality of gaming machine audio systems. In each gaming machine audio system, a mixer is operable to receive the version of the first audio signal and mix it with a second audio signal produced in the gaming machine and feed a mixed signal to an audio power amplifier circuit driving a plurality of audio speakers.

In some implementations of the first aspect, the audio signal distribution module includes a splitter coupled to the microphone amplifier, and multiple cables carrying signals from outputs of the splitter to respective inputs of the mixers of the gaming machines.

In some implementations of the first aspect, an external audio connector is presented at an external surface of a respective cabinet of each of the group of gaming machines and coupled to the respective mixer.

In some implementations of the first aspect, the audio signal distribution module includes an analog-to-digital converter feeding a network interface coupled to a network on which the group of gaming machines is connected. Each of the group of gaming machines is operable to receive the version of the first audio signal over the network and digitally mix the first and second audio signals and feed a resulting digital signal to a digital-to-analog converter.

In some implementations of the first aspect, a configurable public address volume level setting is included for the mixer, with the mixer being operable to provide a designated volume level for the first audio signal responsive to value of the public address volume level setting.

In some implementations of the first aspect, the mixer is further operable to mix a third audio signal with the first and second audio signals, the third audio signal received over a network from a tournament server.

According to another aspect of the invention, a gaming machine system includes a group of gaming machines each including a controller, a display system coupled to the controller, a player interface system coupled to the controller, and an audio system coupled to the controller and including a plurality of audio speakers driven with audio amplifier circuitry coupled to the plurality of speakers for playing game audio events. A tournament controller is connected to the plurality of gaming machines over a network. A group public address system includes a microphone, a microphone amplifier coupled to the microphone, and an audio signal distribution module operable to receive the first audio signal and transmit a version of the audio signal to a plurality of gaming machine audio systems. In each gaming machine audio system, a mixer is operable to receive the version of the first audio signal and mix it with a second audio signal produced in the gaming machine and feed a mixed signal to the audio amplifier circuitry.

In some implementations of the second aspect, the audio signal distribution module comprises a splitter coupled to the microphone amplifier, and multiple cables carrying signals from outputs of the splitter to respective inputs of the mixers of the gaming machines.

In some implementations of the second aspect, an external audio connector is presented at an external surface of a respective cabinet of each of the group of gaming machines and coupled to the respective mixer.

In some implementations of the second aspect, the audio signal distribution module comprises an analog-to-digital converter feeding a network interface coupled to a network on which the group of gaming machines is connected. Each of the group of gaming machines is operable to receive the version of the first audio signal over the network, digitally mix the first and second audio signals in the mixer, and feed a resulting digital signal to a digital-to-analog converter.

In some implementations of the second aspect, a configurable public address volume level setting is included on the mixer, wherein the mixer is operable to provide a designated volume level for the first audio signal responsive to value of the public address volume level setting.

In some implementations of the second aspect, the mixer is further operable to mix a third audio signal with the first and second audio signals, the third audio signal received over a network from a tournament server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 shows a perspective representation of a group of gaming machines for a tournament, and an external PA system.

FIG. 2 shows a perspective representation of a group of gaming machines with an integrated PA system according to some embodiments.

FIG. 3 is a block diagram illustrating an integrated PA system according to some embodiments.

FIG. 4 is a perspective view of a gaming machine including an integrated PA system according to some embodiments.

FIG. 5 shows a hardware and logical block diagram of the gaming machine of FIG. 4.

FIG. 6 is a system block diagram of a gaming system according to one embodiment.

### DESCRIPTION OF REPRESENTATIVE EMBODIMENTS

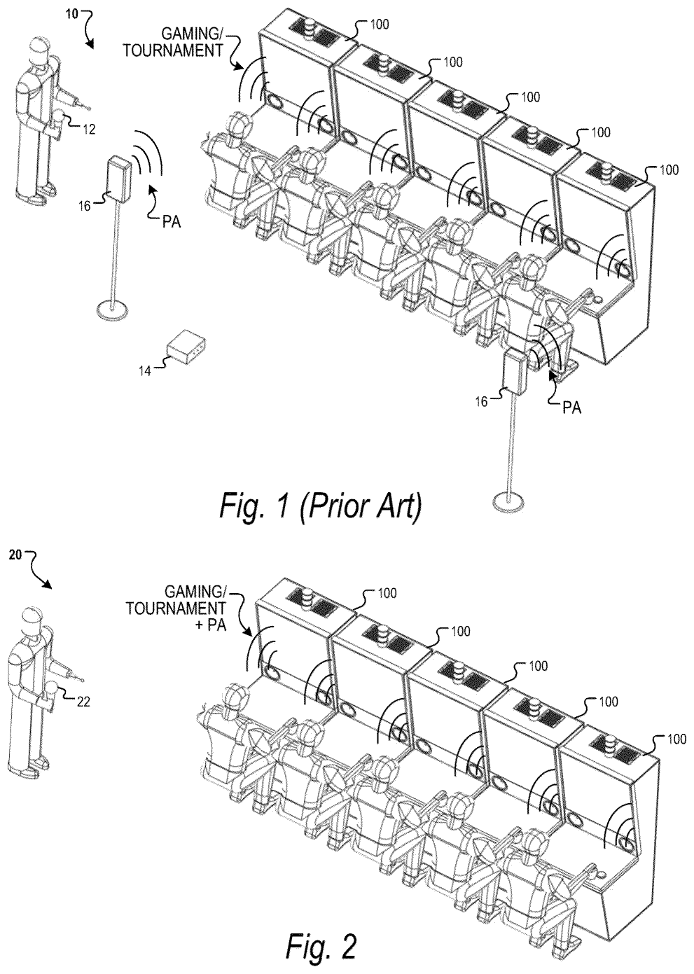

FIG. 2 shows a perspective representation of a group of gaming machines 100 with an integrated PA system 20 according to some embodiments. As compared to the external PA system of FIG. 1, integrated PA system 20 employs the speakers of gaming machines 100 for performing audio from the announcer's external microphone 22. This is illustrated by the sound depicted as emanating from the speakers of gaming machines 100, labelled as “GAMING/TOURNAMENT+PA”.

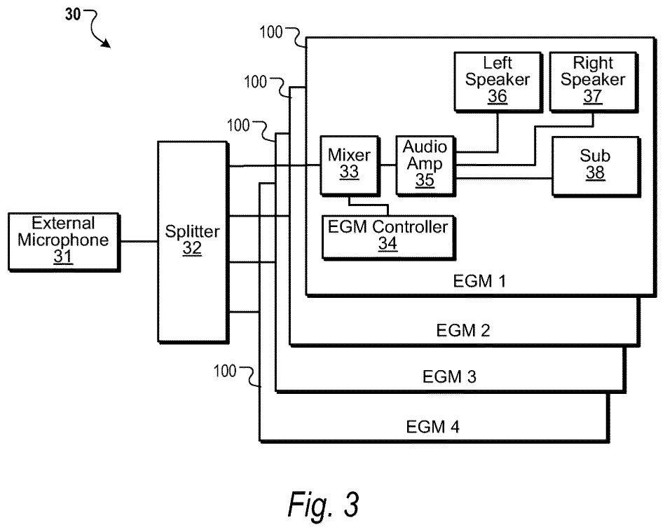

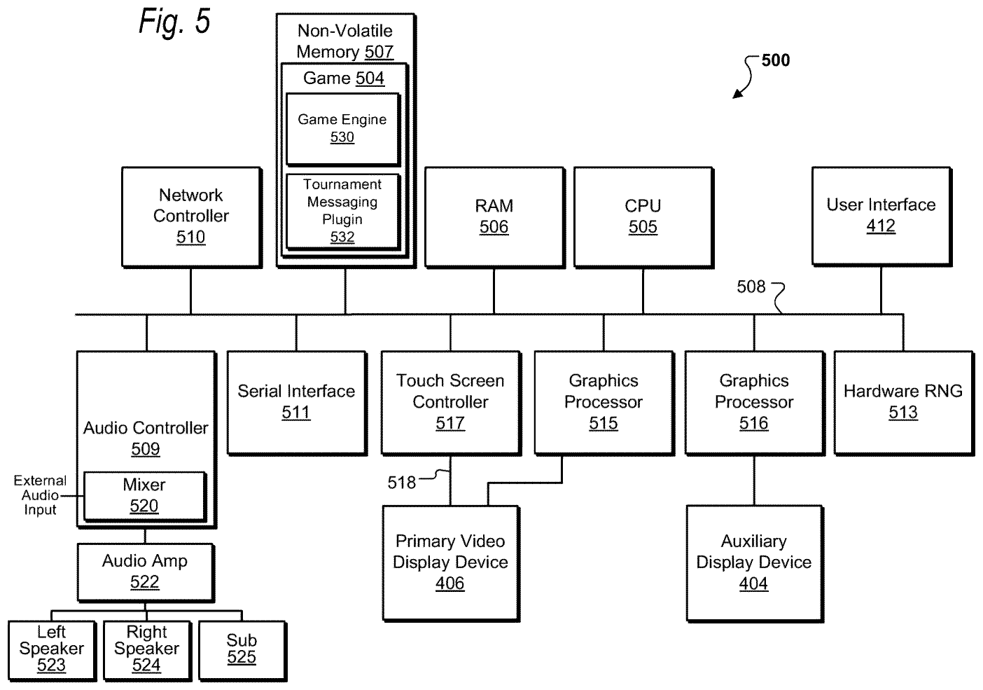

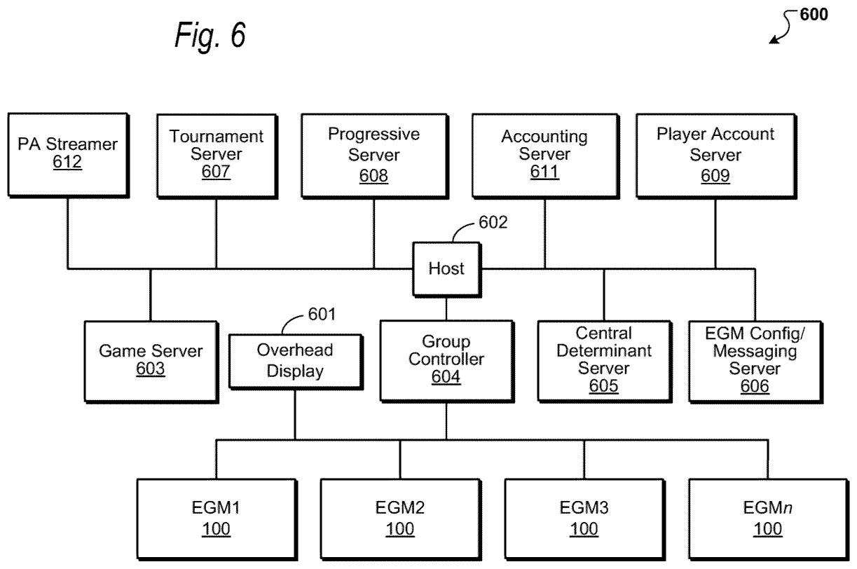

FIG. 3 is a block diagram illustrating one version of an integrated PA system 30 suitable for implementation with the group of gaming machines of FIG. 2. The system of FIG. 3 uses direct connections to provide audio signals from the external microphone 31. Other embodiments may use networked streaming, as illustrated in FIG. 5 and FIG. 6. Referring to FIG. 2 and FIG. 3, in this embodiment a PA system for a group of gaming machines is typically used to perform PA functions during a Slot machine tournament, and includes a microphone amplifier adapted for coupling to a microphone 31 and producing a first audio signal. The microphone amplifier is not shown separately and may be integrated with external microphone 31 or splitter 32, or may be in a separate housing. An audio signal distribution module, in this embodiments splitter 32, operates to receive the first audio signal and transmit a version of the audio signal to a plurality of gaming machine audio systems.

Depicted are four gaming machines 100 (“gaming machine”, “electronic gaming machine”, “EGM”), each including an identical audio system, which is shown for the first gaming machine labelled “EGM 1”. In each gaming machine audio system, a mixer 33 operates to receive the version of the first audio signal from splitter 32 and mix it with a second audio signal produced in the gaming machine and received from EGM controller 34. Mixer 33 feeds the mixed signal to an audio power amplifier circuit 35 for driving a plurality of audio speakers including left speaker 36, right speaker 37, and subwoofer 38. The left and right speakers 36 and 37 are typically presented along the front face of gaming machines 100, such as the speakers illustrated by circles emanating sound in FIG. 2, but may instead be hidden and employ sound ports or other speaker technology such as speakers integrated behind the displays of gaming machines 100. The subwoofer 38 is typically positioned in the lower front portion of gaming machine 100, such as in front of the players legs with reference to the player positions of FIG. 2. More or fewer speakers may be employed in various embodiments. For example, a surround sound system employing five or seven speakers may be used. While the term “audio signal” is used, the various signals may include stereo, subwoofer, or surround sound channels that are mixed. For example, a mono signal from external microphone 31 may be frequency filtered and mixed into left, right, and subwoofer channels that are played through the respective gaming machine speakers.

In this embodiment, the audio signal distribution module is embodied as splitter 32, which is includes a high-impedance input and a number of line level driver amplifiers driving the depicted multiple outputs of splitter 32. Multiple cables carrying signals from the outputs of splitter 32 to respective inputs of the mixers 33 of the respective gaming machines 100. In this embodiment, an external audio connector such as an industry standard RCA plug or HDMI plug (not shown separately) is presented at an external surface of a respective cabinet of each of the group of gaming machines 100 and coupled to the respective mixer 33 from splitter 32. Splitter 32 may be embodied in a separate chassis, positioned behind gaming machines 100 such that only a single cable is needed to connect the microphone's signal to integrated PA system 30. In some embodiments, a wireless connection is used to connected external microphone 31 and splitter 32, and no cable is needed to connect to splitter 32.

Mixer 33 and audio power amplifier 35 may be part of a sound card or other audio module of gaming machine 100, or may be separate circuits. In some embodiments, an analog-to-digital (AD) converter is included before the input of mixer 33, and the mixing is performed digitally in an audio digital signal processor (DSP) or other specialized chip. An analog mixer may instead be used. EGM controller 34 provides an audio signal to a second input of mixer 33 including audio produced by the gaming machine 100 for performing the game. This audio signal may include audio transmitted digitally from a tournament server (FIG. 6). The audio from EGM controller 34 includes at least gaming audio produced by the individual gaming rounds of whatever slot game a particular player is playing in the tournament. This audio may also include other audio that is produced by gaming machines, such as music selected by the player, and other interface audio sound prompts, for example.

In operation, when integrated PA system 30 is active, the audio signal from the announcer's external microphone 31 is amplified to an industry standard line level, split by splitter 32, and fed to each gaming machine where it is mixed with the gaming and/or tournament audio and performed by the gaming machine speakers. This presents an advantage that players do not have to listen to audio from different external sources to hear the announcer's dialog during a tournament. Mixer 33 may include a configurable volume level, which may be remotely configured through the tournament gaming interface, in addition to a volume control on external microphone 31. Such a configurable volume level may set a maximum level for PA system audio, or may be set to achieve a desired power level for PA system audio even when the volume of a particular gaming machine audio system has been decreased by a player, such that the player can always hear a strong audio performance of sound from integrated PA system 30.

While a group of four gaming machines 100 are shown in FIG. 3, typically a tournament includes many more gaming machines. Integrated PA system 30 may include nested splitters for connecting to much larger groups of gaming machines. Wireless distribution of the PA audio signal from external microphone 31 is more advantageous with larger groups of gaming machines participating in a tournament. When gaming machines are positioned in multiple rows, the integrated PA systems described herein also have the advantage of providing PA audio to players in all areas of the tournament, where it would be cumbersome to position enough external speakers to reliably reach all players using an external PA system such as that of FIG. 1. Further, while use of the PA system for a tournament is described, the integrated PA systems herein may be used in other situations where groups of slot machine players require some form of public address.

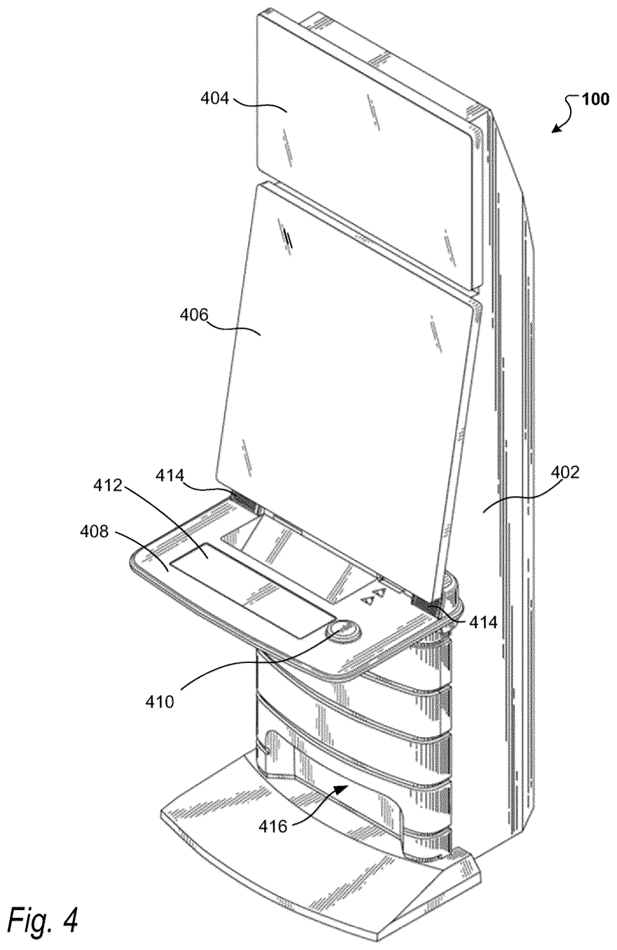

FIG. 4 is a perspective view of a gaming machine 400 which is suitable for use as the gaming machines 100 of FIG. 2-FIG. 3 for implementing the integrated PA systems described herein. Gaming machine 400 includes a cabinet 402 that houses various elements of the gaming machine, in this embodiment is a Dynasty Vue™ gaming machine cabinet available from Everi Games, Inc. A front side of cabinet 402 supports an upper display device 404 and a lower display device 406. The front side of cabinet 402 also supports a button deck 408 that contains various player controls and interface devices including play button 410 and a touch screen button panel 412. Left and right audio speakers 414 are installed below lower display device 406, and a subwoofer speaker 416 is installed in the lower front based of cabinet 402. As can be understood, in this embodiment, lower display device 406 provides a primary game display, and upper display device 404 provides a secondary game display which may include tournament data.

It will be appreciated that gaming machines may also include a number of other player interface devices in addition to devices that are considered player controls for use in entering inputs in the course of a particular game. For example, gaming machine 400 may include a currency/voucher acceptor, a voucher/receipt printer having a voucher/receipt printer, and a player card reader although these elements are not called out in FIG. 4.

FIG. 5 shows a hardware and logical block diagram of gaming machine 500 suitable for implementing a gaming machine with an integrated PA system as described herein. Gaming machine 500 includes an EGM controller with a central processing unit (CPU) 505 along with random access memory 506 and nonvolatile memory 507, which includes one or more non-volatile storage devices such as HDDs, SSDs, or flash memories. Gaming machine 500 may embody a special purpose gaming machine including a hardware configuration approved by a regulatory gaming authority for use in casino gaming. Examples of such gaming authorities include the National Indian Gaming Commission (NIGC), the Arizona Department of Gaming, the California Bureau of Gambling Control, the California Gambling Control Commission, the Delaware Division of Gaming Enforcement, the Illinois Gaming Board, the Michigan Gaming Control Board, the Minnesota Alcohol and Gambling Enforcement Division, the Missouri Gaming Commission, the Nevada Gaming Commission, the Nevada Gaming Control Board, the New Jersey Casino Control Commission, the New Jersey Division of Gaming Enforcement, the New York State Gaming Commission, the Ohio Casino Control Commission, the Pennsylvania Gaming Control Board, the South Dakota Commission on Gaming, the Washington State Gambling Commission, and the West Virginia Lottery. Other similar non-U.S. gaming commissions may also approve such special purpose hardware.

The depicted devices of gaming machine 500 are connected on a system bus 508 with an audio controller 509, a network controller 510, and a serial interface 511. A graphics processor 515 is also connected on system bus 508 and is connected to drive primary video display device 406 (mounted in cabinet 402 as shown in FIG. 4). A second graphics processor 516 is also connected on system bus 508 in this example to drive the auxiliary display device 404. Gaming machine 500 also includes a touch screen controller 517 connected to system bus 508. Touch screen controller 517 is also connected via signal path 518 to receive signals from a touchscreen element associated with primary video display device 406. The touchscreen element itself typically comprises a thin film that is secured over the display surface of primary video display device 406. The touchscreen element itself is not illustrated or referenced separately in the figures, and is not used in some embodiments.

Those familiar with data processing devices and systems will appreciate that other common electronic components will be included in gaming machine 500 such as a power supply, cooling systems for the various system components, audio amplifiers, and other devices that are common in gaming machines. These additional devices are omitted from the drawings so as not to obscure the present invention in unnecessary detail.

Generally, the hardware elements shown in FIG. 5 are known elements used in the gaming machine industry. These elements are preferably mounted in a computer chassis which is housed in the gaming machine's cabinet, such as cabinet 402 shown in FIG. 4. Alternatively, the various electronic components may be mounted on one or more circuit boards or modules housed in the cabinet without a separate enclosure. Those familiar with data processing systems and the various data processing elements shown in FIG. 5 will appreciate that many variations on this illustrated structure may be used within the scope of the present invention. For example, since serial communications are commonly employed to communicate with a touch screen controller such as touch screen controller 517, the touch screen controller may not be connected on system bus 508, but instead include a serial communications line to serial interface 511, which may be a USB controller or a IEEE 1394 controller for example. It will also be appreciated that some of the devices shown in FIG. 5 as being connected directly on system bus 508 may in fact communicate with the other system components through a suitable expansion bus. Audio controller 509, for example, may be connected to the system via a PCI bus. System bus 508 is shown in FIG. 5 merely to indicate that the various components are connected in some fashion for communication with game processor/CPU 505 and is not intended to limit the invention to any particular bus architecture. Numerous other variations in the gaming machine internal structure and system may be used without departing from the principles of the present invention.

Although separate graphics processor 515 is shown for controlling primary video display device 80, and graphics processor 516 is shown for controlling auxiliary display device 404, it will be appreciated that game processor/CPU 505 may control all of the display devices directly without any intermediate graphics processor, particularly if the CPU is a system on chip which contains suitable graphics processing capability with multiple processor cores connected by an internal data fabric. The invention is not limited to any particular arrangement of processing devices for controlling the video display device included with gaming machine 500. Also, a gaming machine implementing the present invention is not limited to any particular number of video display devices or other types of display devices.

In the illustrated gaming machine 500, game processor/CPU 505 executes software which ultimately controls the entire gaming machine including the receipt of player inputs and the presentation of the graphic symbols displayed according to the invention through the display devices 406 and 404 associated with the gaming machine. As will be discussed further below, game processor/CPU 505 either alone or in combination with graphics processor 515 may implement a presentation controller for performing functions associated with a primary game that may be available through the gaming machine, and may also implement a game client for directing one or more display devices at the gaming machine to display the feature game mode according to the present invention. Game processor/CPU 505 also executes software related to communications handled through network controller 510, and software related to various peripheral devices such as those connected to the system through audio controller 509, serial interface 511, and touch screen controller 517. Game processor/CPU 505 may also execute software to perform accounting functions associated with game play. Random access memory 506 provides memory for use by game processor/CPU 505 in executing its various software programs, while the nonvolatile memory 507 may comprise a hard drive or other mass storage device providing storage for programs not in use or for other data generated or used in the course of gaming machine operation. Network controller 510 provides an interface to other components of a networked gaming system in which gaming machine 500 is included.

It should be noted that the invention is not limited to gaming machines employing the arrangement of processing devices and interfaces shown in example gaming machine 500. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 505, these special purpose processing devices may not employ operational program code to direct the various processing steps.

Still referring to FIG. 5, in operation gaming machine 500 is controlled generally by game processor/CPU 505 which stores operating programs and data in non-volatile memory 507 with game software module 504, and software or drivers for user interface 412, network controller 510, audio/visual controllers, and a hardware random number generator (RNG) 513, which is employed if software RNG procedures are not allowed in a particular gaming jurisdiction. Either hardware RNG 513 or a suitable software RNG are employed for making the random selections of game outcomes, reel stop positions, etc. when operating a game, in regular play mode or in a tournament mode for the tournament system as described herein. Game processor/CPU 505 connects to user interface 412 such that a player may enter input information, and game processor/CPU 505 may respond according to its programming, such as to apply a wager or tournament game activation and initiate execution of a game. Game processor/CPU 505 connects through network controller 510 to a gaming network, such as example casino server networked gaming system 600 shown in FIG. 6.

The game software module 504, once installed, also is held in non-volatile memory of the gaming machine, preferably a separate flash drive or hard drive from the memory holding the gaming machine operating system. Game processor/CPU 505 may comprise a conventional microprocessor, such as an Intel microprocessor, mounted on a printed circuit board with supporting ports, drivers, memory, software, and firmware to communicate with and control gaming machine operations, such as through the execution of code stored in non-volatile memory 507. Such executed code includes a game software 504 for executing one or primary game modules and includes software for controlling the graphical presentation of one or more slot machine games such as virtual reel-based games. In embodiments using a mechanical reel assembly to present the base game, the game software module includes software and firmware for controlling a mechanical reel presentation through a mechanical reel controller.

Non-volatile memory 507 in this embodiment also holds a gaming engine 530, which is able to execute scripts to execute multiple different games using a common graphics and gaming math framework. In other embodiments, game software module 504 may be stand alone, without a gaming engine involved in the execution of a game. Nonvolatile memory 507 also holds the EGM operating system and may include separate modules verified for regulatory compliance such as a prize generator for producing randomized game outcomes, either with a random number generator or by request to a gaming outcome server such as central determinant server 405 (FIG. 6). Non-volatile memory 507 also holds tournament messaging plugin software or firmware 532, which is executed by CPU 505 to perform the interface processes and techniques described herein for providing control of gaming machine 500's participation in the tournament system, including tracking game outcomes and messaging the tournament server (FIG. 6) with game play data while the game is participating in a tournament. Tournament messaging plugin 532 may also configure audio streams to receive tournament-specific audio, or receive integrated PA system audio for embodiments in which network streaming is employed for PA system audio distribution.

In this embodiment, audio controller 509 is an integrated audio module such as a soundcard and includes a digital version of the mixer for the integrated audio system, mixer 520. One or more outputs of audio controller 509 connect to an audio power amplifier 522, which may be any suitable amplifier capable of driving the various speakers of the cabinet. For example, a class D, class A, class B, or class AB amplifier may be used, with a separate low impedance output for driving each of left, right, and subwoofer speakers 523, 524, and 525. Mixer 520 receives PA system audio via a network stream through network controller 510, and mixes it with gaming machine

In operation, for embodiments of an integrated PA system with network audio streaming, the audio signal distribution module does not include a splitter 32 (FIG. 3), and instead includes an analog-to-digital converter feeding a network interface coupled to a network on which the group of gaming machines is connected, as further described with respect to FIG. 6. Each gaming machine participating in the integrated PA system operates to receive the version of the PA system audio signal from external microphone 22 over the network and digitally mix the signal with a second audio signal and feed the a resulting digital signal to a digital-to-analog converter.

The gaming machine functionality as described herein is controlled by the system processor by executing program code, executable by CPU 505 to accomplish the functionality as described herein. It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” The division of game logic steps between gaming machines and servers is known in the art and may be accomplished according to suitable methods allowed for the relevant gaming jurisdictions.

Referring now to FIG. 6, a networked gaming system 600 associated with one or more gaming facilities may include one or more networked gaming machines 100 (shown in FIG. 6 as EGM1-EGMn) connected in the network by suitable network cabling or wirelessly. Networked gaming machines 100 and one or more overhead display devices 601 may be operatively connected so that the overhead display device or display devices may mirror or replay the content of one or more displays of gaming machines 100. For example, the display content for a given gaming machine 100 (including a base game, bonus game, or tournament game) may be transmitted through network controller 510 to a controller associated with the overhead display device(s) 601. In the event gaming machines 100 have cameras installed, the respective player's video images may be displayed on overhead display device 601 along with the content of the player's gaming machine display.

The example networked gaming system 600 shown in FIG. 6 includes a host server 602 and group controller 604, that together may function as an intermediary between floor devices such as gaming machines 100 and back-office devices such as the various servers described below. Game server 603 may provide server-based games and/or game services to network connected gaming devices such as gaming machines 100. Group controller 604 performs functions for group control of the group jackpot game for group functions such as group games which share a common overhead display 601. Generally, agroup controller 604 may receive messaging from gaming machines EGM1-EGMn to determine their eligibility to participate in group games, including receiving messages indicating their wager denomination, and when they start and end game presentations such as group bonus games. Central determinant server 605 may be included in the network to identify or select lottery, bingo, or other centrally determined game results and provide the result information to networked gaming machines 100 that present the games or game results to players.

EGM configuration and messaging server 606 may provide game and non-game content and operational software for use by the gaming machines 100 in the course of providing games and while the gaming machines are unused and in an idle state. For example, server 606 may control the distribution of game software and graphic control assets to the gaming machines as well as advertising messages and other messages that may be presented using a display device of a gaming machine 100. EGM configuration and messaging server 606 may also be used to direct candle control software to gaming machines 100 that include a system in accordance with aspects of the present invention.

PA streamer 612 is a networked streaming device having an input for receiving an audio signal from an external microphone (22, FIG. 2). PA streamer 612 is one implementation of an audio signal distribution module and functions as part of integrated PA system to distribute PA audio received from the external microphone to the gaming machines participating in the tournament, directly or indirectly. In some embodiments, PA streamer comprises an analog-to-digital converter feeding a network interface coupled to the depicted network on which the group of gaming machines is connected. The digital version of the PA audio is streamed. The stream may be directly from PA streamer 612 to the gaming machines, or may pass to an intermediate server such as tournament server 607 for coordination. Each of the group of gaming machines 100 is operable to receive the streamed version of the audio signal over the network and digitally mix the PA audio in that streamed version with a second audio signal produced by the gaming machine containing game play audio. The resulting digital signal is fed to a digital-to-analog converter and audio amplifier as described above with respect to FIG. 5.

PA streamer 612 may be configurable through a user interface, or through a remote configuration application running on tournament server 607, in order to select gaming machines to receive the PA audio streaming signal. In other embodiments, the PA streamer transmits the PA audio streaming signal to tournament server 606, which distributes it to a configured group of gaming machines. Such functionality allows gaming machine speaker systems to operate as an addressable PA system for a tournament, and as a PA system for casino-wide announcements, Tournament server 607 is included in the system for controlling or coordinating tournament functions, including grouping gaming machines 100 into a tournament group. These functions may also include maintaining tournament player scores and ranking during the course of tournament play, and communicating this information to the various gaming machines 100 participating in the tournament. Tournament server 607 may also function to enroll players in tournaments, schedule tournaments, and maintain the time remaining in the various tournaments. Tournament server 607 may also coordinate audio streams related to tournament play in progress. For example, tournament server 607 may transmit an audio stream to EGMs 100, to be mixed with audio produced by the individual gaming machines, containing tournament audio. Tournament server 607 may also coordinate with PA streamer 612 to direct the public address audio stream to the group of gaming machines participating in the tournament.

Progressive server 608 may maintain progressive pools for progressive games that may be available through the various gaming machines 100, including the group jackpot awards described herein. In some implementations, progressive server 608 may simply receive communications indicating contribution amounts that have been determined by processes executing at the various gaming machines 100 or elsewhere in the gaming network. Alternatively, progressive server 608 may perform processes to determine the contribution amounts for incrementing the various progressive pools that may be maintained. Progressive server 608 may also periodically communicate current pool values back to the various gaming machines 100 and may participate in communicating awarded progressive prize amounts to the gaming machines and in adjusting the progressive prize pools accordingly. In some implementations, progressive server 608 may also determine or participate in determining when a progressive prize triggering event occurs.

Accounting server 611 may receive gaming data from each of the networked gaming devices, perform audit functions, and provide data for analysis programs. Player account server 609 may maintain player account records, and store persistent player data such as accumulated player points and/or player preferences (for example, game personalizing selections or options).

Networked gaming system 600 illustrated in FIG. 6 is provided merely as an example of a gaming network that may include gaming machines with an integrated PA system according to aspects of the present invention and is not intended to be limiting in any way. Gaming machines controlled according to aspects of the present invention are not limited to use with gaming networks such as networked gaming system 600.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of the invention, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A public address system for a group of gaming machines comprising:
a microphone amplifier adapted for coupling to a microphone and producing a first audio signal;
an audio signal distribution module operable to receive the first audio signal and transmit a version of the first audio signal to a plurality of gaming machine audio systems; and
in each gaming machine audio system, a mixer operable to receive the version of the first audio signal and mix it with a second audio signal produced in the gaming machine and feed a mixed signal to an audio power amplifier circuit driving a plurality of audio speakers.

2. The public address system of claim 1 wherein:
the audio signal distribution module comprises a splitter coupled to the microphone amplifier, and multiple respective cables carrying signals from outputs of the splitter to respective inputs of the mixers of respective ones of the gaming machines.

3. The public address system of claim 1 further comprising:
an external audio connector presented at an external surface of a respective cabinet of each of the group of gaming machines and coupled to the respective mixer.

4. The public address system of claim 1 wherein:
the audio signal distribution module comprises an analog-to-digital converter feeding a network interface coupled to a network on which the group of gaming machines is connected; and
each of the group of gaming machines is operable to receive the version of the first audio signal over the network and digitally mix the first and second audio signals and feed a resulting digital signal to a digital-to-analog converter.

5. The public address system of claim 1 further comprising:
a configurable public address volume level setting for the mixer, wherein the mixer is operable to provide a designated volume level for the first audio signal responsive to value of the public address volume level setting.

6. The public address system of claim 1 wherein:
the mixer is further operable to mix a third audio signal with the first and second audio signals, the third audio signal received over a network from a tournament server.

7. A gaming machine system comprising:
a group of gaming machines each including a controller, a display system coupled to the controller, a player interface system coupled to the controller, and an audio system coupled to the controller and including a plurality of audio speakers driven with audio amplifier circuitry coupled to the plurality of audio speakers for playing game audio events;
a tournament controller coupled to the plurality of gaming machines over a network; and
a group public address system comprising a microphone, a microphone amplifier coupled to the microphone, and an audio signal distribution module operable to receive a first audio signal from the microphone and transmit a version of the first audio signal to a plurality of gaming machine audio systems; and
in each gaming machine audio system, a mixer operable to receive the version of the first audio signal and mix it with a second audio signal produced in the gaming machine, and feed a resulting mixed signal to the audio amplifier circuitry.

8. The gaming machine system of claim 7 wherein:
the audio signal distribution module comprises a splitter coupled to the microphone amplifier, and multiple respective cables carrying signals from outputs of the splitter to respective inputs of the mixers of the gaming machines.

9. The gaming machine system of claim 7 further comprising:
an external audio connector presented at an external surface of a respective cabinet of each of the group of gaming machines and coupled to the respective mixer.

10. The gaming machine system of claim 7 wherein:
the audio signal distribution module comprises an analog-to-digital converter feeding a network interface coupled to the network on which the group of gaming machines is connected; and
each of the group of gaming machines is operable to receive the version of the first audio signal over the network, digitally mix the first and second audio signals in the mixer, and feed a resulting digital signal to a digital-to-analog converter.

11. The gaming machine system of claim 10 wherein:
the audio signal distribution module is configured to perform a network broadcast of the version of the first audio signal over the network to a first configurable set of gaming machines over the network.

12. The gaming machine system of claim 7 further comprising:
a configurable public address volume level setting for the mixer, wherein the mixer is operable to provide a designated volume level for the first audio signal responsive to value of the public address volume level setting.

13. The gaming machine system of claim 7 wherein:
the mixer is further operable to mix a third audio signal with the first and second audio signals, the third audio signal received over the network from the tournament controller.

14. The gaming machine system of claim 13 wherein:
the tournament controller is configured to perform a network broadcast of the third audio signal to a selected sub-group of gaming machines on the network, the selected sub-group of the gaming machines configurable at the tournament server.
